(19) United States
(12) Patent Application Publication
(10) Pub. No.: US 2007/0030482 A1
(43) Pub. Date: Feb. 8, 2007

(54) Spectrophotometer with adjustable light pathlength

(76) Inventors: Zhenghua Ji, Wilmington, DE (US); Dianne Rees, Sunnyvale, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/199,836

(22) Filed: Aug. 8, 2005

(51) Int. Cl. G01J 3/42

(52) U.S. Cl. 356/319; 356/246

(57) ABSTRACT

A spectrophotometer used to analyzing a sample. The spectrophotometer comprises a light source and a detector. An optical assembly defines at least one light path, the light path arranged to carry light from the light source through a sample, and received by the detector, wherein a pathlength of the light through the sample is varied by adjusting an angle of incidence of the light through the sample.

### BACKGROUND

Spectrophotometry is widely used in applications for measuring concentrations of chemical compounds and determining molecular structure of chemicals. Usually a sample is obtained from one or more locations in a chemical processing system and analyzed in a laboratory. Spectrophotometry operates on the principle that certain compounds will absorb certain wavelengths (i.e., colors) of light. Light having known intensity at a variety of wavelengths is projected into one side of a sample vessel of a predetermined size that contains a sample such as a liquid, mixture, solution, reacting mixture, or the like. The length of the light that travels inside sample is the pathlength of the travel light. The light is detected after it exits the sample vessel. The detected light is analyzed for the reduced intensity levels of certain wavelengths of light. This information, along with the pathlength, is used to identify and measure the concentration of compounds in the sample.

Several devices perform these measurements. For example, a spectral analysis apparatus provides a light source and optical fiber wave guides to pass light through a sample of a chemical and back to an analyzer. A mirror or prism can be used to reflect light between optical fibers or other components of the apparatus.

In spectrophotometry measurements, the pathlength is an important parameter to affect absorbance reading for measurements. A spectrophotometer typically has a designed linear dynamic range to work for wide range of sample measurement. Liquid chemical absorbance measurements using conventional spectrophotometers employ sample vessels, such as cuvettes or cells, for holding the sample to be analyzed. These cells have a fixed pathlength, for example, 1 mm, 2 mm, or 10 mm. However, if the pathlength of the cell is too short, it may be difficult to get the liquid sample into the cell. It is also possible to have within a given spectrum two or more absorbance peaks located in different portions of the spectrum, which cannot both be accurately measured because the cell pathlength has been optimized for the absorbance typical of only one of them. A single pathlength can only quantitate optimally one absorbance peak if there is a large difference is absorbance values between peaks.

Also, when many tests are performed using a single sample, it is then natural to use a very small portion of the sample for each test, reducing sampling volume in each test as well as the pathlength. As a result, the pathlength of the sample portion becomes inadequate for a valid and accurate measurement.

### SUMMARY

In general terms the present invention relates to a spectrophotometric measurement by adjusting an angle of incidence of light through a sample to vary a pathlength of the light.

In one embodiment, a method of spectrophotometric measurement of a sample includes passing a light through a sample, adjusting an angle of incidence of the light to vary a pathlength of the light passed through the sample, and measuring the intensity of the light that passed through the sample. In one aspect, the measured intensity of the light that has passed through the sample is used to determine the absorbance of the light.

In another aspect, the method includes transmitting a light through the sample a first time, reflecting the light off a surface normal to the sample as to conduct the light through the sample a second time, and determining the absorbance of the light emitted from the sample the second time by measuring the intensity of the emitted light.

In another aspect, reflecting the light off the surface further includes reflecting the light off an optical reflective material.

In another aspect, adjusting the angle of incidence further includes increasing the pathlength by increasing an angle of incidence of the light through the sample.

In another aspect, adjusting the angle of incidence further includes decreasing the pathlength by decreasing the angle of incidence of the light through the sample.

In another aspect, determining the absorbance further includes performing blanking by measuring an absorbance level when the sample is a blanking sample.

In another aspect, conducting a light through a sample further includes providing at least one optical fiber providing a first light path from a light source to the sample and at least one optical fiber providing a second light path from the sample to a detector, and the act of passing the light between the first and second light paths through the sample includes adjusting the positions of the first and/or second light paths to optimize the intensity measurement.

In another aspect, providing at least one optical fiber forming the first and second light paths further includes conducting light from the sample to the detector, and the act of conducting light from the sample to the detector includes conducting light along at least one optical fiber coupled to the detector.

In another aspect, in another aspect, transmitting light from the sample to the detector further includes projecting the light onto a charge-coupled device.

In another aspect, transmitting light from the samples to the detector further includes projecting the light onto a photoelectric sensor.

In another aspect, transmitting the light through a sample further includes transmitting the light through a sample vessel having a sample depth of about 0.1 to 5 mm.

In another aspect, determining the absorbance further includes processing an absorbance measurement signal generated by the detector.

In another embodiment, a spectrophotometer for analyzing a sample is provided. The spectrophotometer includes a light source, and an optical assembly arranged to receive light from a light source and to project the light through the sample, the optical assembly configured to vary an angle of incidence of the light projected through the sample. In one aspect, the spectrophotometer further includes a carrier for receiving a sample vessel for holding a sample. In another aspect, the spectrophotometer further includes the sample vessel.

In a further embodiment, the invention provides a sample vessel comprising a plurality of walls, only one of which is capable of transmitting light. In one aspect, the sample vessel further comprises an optical reflective surface.

In another embodiment, the spectrophotometer further includes a reflective surface to reflect the light through the sample, and a detector arranged to detect the reflected light. In one aspect the detector includes a charge-coupled device.

In another aspect, the optical assembly is coupled to at least one optical fiber arranged between the light source and the sample.

In another aspect, the optical assembly includes at least one lens positioned between the optical fiber and the sample, the at least one lens configured to vary a pathlength of the light through the sample by adjusting an angle of incidence of the light radiated from the optical fiber with the reflective surface. In yet another aspect, the optical assembly is coupled to at least one optical fiber arranged between the sample and the detector.

In another aspect, the optical fiber arranged between the sample and the detector has a first end positioned to receive light from the sample and a second end positioned to direct light onto the detector.

In another aspect, the optical assembly further comprises at least a first lens positioned between an optical fiber and the sample for varying a pathlength of the light through the sample, and at least a second lens positioned between the sample and the detector to receive light from the sample, wherein at least first and second lenses are adjusted to optimize an intensity measurement of reflected light.

In another aspect, the sample vessel includes the optically reflective surface and light transmittable surface having an open surface to the sample.

In another aspect, an optically reflective surface is positioned at a predetermined distance from the sample vessel.

In another aspect, a processor is used for determining the absorbance of reflected light by processing a signal representing the intensity of the reflected light emitted from sample.

### DESCRIPTION OF THE DRAWINGS

FIG. 1 illustrates an embodiment of varying a pathlength of light through a sample;

FIG. 2 illustrates a spectrophotometer for varying the pathlength of light through a sample contained in a vessel having a reflective surface;

FIG. 3 illustrates determining the pathlength of light through the sample illustrated in FIG. 2;

FIG. 4 illustrates a spectrophotometer system having an adjustable angle of incidence for varying the pathlength of light through a sample; and

FIG. 5 is an alternate embodiment for increasing pathlength of a light beam through a sample contained in a vessel having a non-reflective surface.

### DETAILED DESCRIPTION

Various embodiments will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

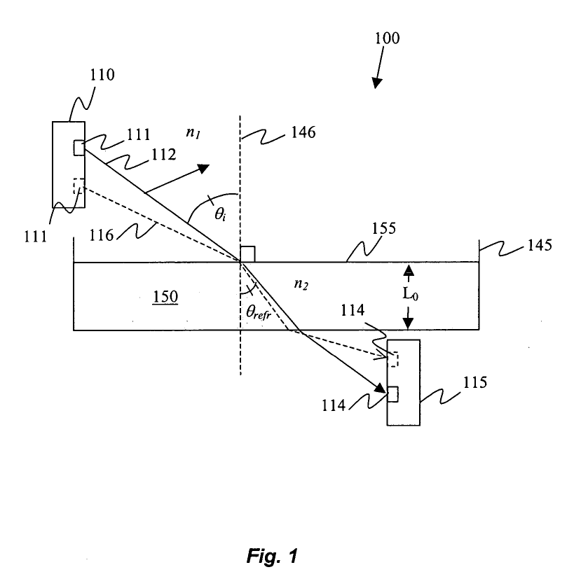

FIG. 1 illustrates an embodiment of a system for varying the pathlength of a light beam through a sample, generally shown as 100. A light source 1 10 provides one or more lamps 111 for generating a light beam 112. The light beam 112 is projected through a sample 150 contained in a sample vessel 145 and having a depth of L₀. The light beam 1 12 is projected through the sample 150 at an angle of incidence θᵢ and detected by a signal receiver device 115. In the embodiment shown in FIG. 1, the range between the angle of incidence θᵢ and the normal 146 can be 5 to 89 degrees. However, any suitable range can be used. The signal receiver device 115 includes one or more detectors 114.

The lamps 111 are movable in the light source 110 and the detectors 114 are movable in the signal receiver device 1 5 allowing the angle of incidence θᵢ, and a pathlength through the sample, to be adjusted as illustrated by the light beam 116. In one aspect, the positions of the detectors 114 and/or lamps 111 are adjusted so that emitted light from the lamps 111 is substantially maximally received by detectors 114.

As the light beam 112 passes from a first medium n₁ to a second medium n₂, it changes speed and bends. The extent to which this happens depends on the refractive index of the mediums and the angle between the light beam 112 and the line perpendicular (normal) 146 to the surface 155 separating the two mediums. Each medium can have a different refractive index. The angle between the light beam 112 and the normal 146 in the first medium n₁ is called the angle of incidence θᵢ. The angle between the light beam 112 and the normal 146 as the light enters the second medium n₂ is called the angle of refraction θ_{refr}.

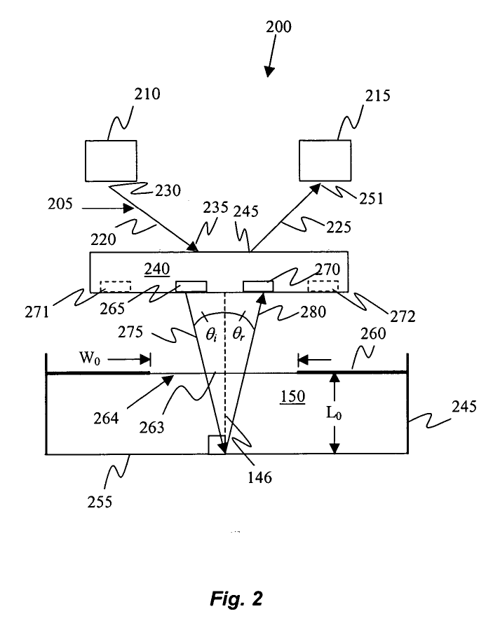

FIG. 2 illustrates a spectrophotometer according to one embodiment of the invention, generally shown as 200. The spectrophotometer 200 includes a light path 205 that extends between a light source 210 and a signal receiver device 215. In certain non-limiting aspects, a light path can be defined by providing an optical fiber, light guide, or other light-transmitting structure. Other embodiments, however, might provide different light paths or structures to define a light path 205. In certain aspects, a spectrophotometer according to embodiments of the invention can also include a plurality of light paths 205.

In one aspect, the light path 205 is defined by an input optical fiber 220 and an output optical fiber 225. The input optical fiber 220 has first and second ends, 230 and 235, extending between the light source 210 and an optical assembly 240, and the output optical fiber 225 has first and second ends, 245 and 251, extending between the optical assembly 240 and the signal receiver device 215.

The light source 210 can include a lamp for generating light and appropriate input optics arranged to couple light from the lamp into the first end 230 of the optical fiber 220. In another embodiment, the first end 230 can include multiple optical fibers bundled so that the multiple optical fibers collect light from the light source 210 for travel along the light path 205.

In one embodiment, the light source 210 includes a broadband light source such as a Xenon flash lamp providing light in the ultraviolet, visible, and near infrared spectrum or in the range of about 200 to about 1000 nm. Although in the embodiment shown in FIG. 2, the light source 210 is a single lamp with appropriate optics to couple light into the input optical fiber 220, alternative embodiments include separate lamps for a plurality of input optical fibers, each separate lamp arranged to direct light into a separate, individual input optical fiber or into small groups of fibers that are within the main group of input optical fibers. Additionally, the light source 210 can output light having various ranges of wavelengths other than the exemplary embodiment and also can include other types of devices for generating light such as incandescent lamps, light emitting diodes (LEDs), as well as dual sources such as separate deuterium and tungsten lamps.

In one embodiment, the optical assembly 240 is coupled to the input optical fiber 220 and output optical fiber 225. The optical assembly 240 is positioned proximate a sample vessel 245 so that the light path 205 passes into the sample 150. In an exemplary embodiment, the optical assembly 240 is arranged to project light into the sample vessel 245 and into the sample 150 at varying angles (for simplicity, the angle of refraction is not shown in the figure). An example of a sample vessel 245 includes, but is not limited to, a cuvette, capillary, standard spectrophotometer cell and fiber optic surfaces such as provided in NanoDrop® devices. One possible embodiment uses sample vessels containing a sample 0.1 mm to 5 mm in depth (L₀). Other embodiments utilize sample vessels having different volumes and depths as well.

In another embodiment, the sample vessel 245 includes an optical reflective material 255, such as aluminum or silver, which will reflect light creating an angle of reflection within light path 205. In general, the angle of incidence θᵢ of a beam of light transmitted on to the light path 205 is the angle measured from the transmitted beam to a surface normal 146. From the law of reflection, θᵢ=θᵣ, where θᵣ is the angle of reflection. θᵣ is measured between the reflected beam of transmitted light 280 and a line normal to the surface that intersects the surface 264 at the same point as the transmitted or emitted beam of light 275.

The sample vessel 150 can include a sample cover 260 made of, for example, a non-optical material (i.e., a material which transmits less than about 30% electromagnetic radiation, less than about 15% electromagnetic radiation, or less than about 5% electromagnetic radiation of wavelength being detected by the spectrophotometer being used). In one aspect, the sample vessel contains a single surface comprising an optically transmissible material. For example, in one aspect, the sample vessel comprises a plurality of walls and/or a cover and only one of the walls or the cover comprises an optically transmissible material.

In one aspect, the sample cover 260 includes a window 263 or optically transmittable material allowing the light path 205 to pass into and out of the sample 250 and sample vessel 245. The width (W₀) of window 265 is:
W₀≧2L₀ tan(θ_{i max}) (1)

In another aspect, the optical assembly 240 includes fiber optics and angle adjustment mechanisms to dynamically change the angle of the light path 205, or angle of incidence θᵢ, conducted through the sample 150 relative the normal 146. The optical assembly 240 can include, for example, an optical output device 265 and an optical input device 270.

The optical output device 265 can adjust the angle of the light path 205 so an optimum angle is acquired through the sample 150, i.e., providing a sufficient absorbance reading. Electro-mechanical controls (not shown) can be provided in the optical assembly 240 for moving the optical output device 265 and adjusting the angle of incidence θᵢ of the emitted beam of light 275. For example, by moving the optical output device 265 to another position 271, the angle of incidence θᵢ and the pathlength through the sample 150 can be increased. The optical output device 265 generally provides a movable structure that can vary the angle of incidence θᵢ of the light beam 275 by moving the optical output device 265 within the optical assemble 240. In one embodiment, the optical output device 265 can include, but is not limited to, one or more optical lenses housed in a movable structure within the optical assemble 240. In another embodiment, the optical output device 265 is a movable optical fiber. In yet another embodiment, the optical output device 265 includes multiple lenses, each movable and configured to change the direction of the light beam 275.

Similarly, the optical input device 270 generally provides a movable structure that can adjust or synchronize to a change in the angle of incidence θᵢ of the light beam 275 by moving within the optical assemble 240. In one embodiment, the optical input device 270 can include, but is not limited to, one or more optical lenses housed in a movable structure within the optical assemble 240. In another embodiment, the optical input device 270 is a movable optical fiber. In yet another embodiment, the optical input device 270 includes multiple lenses, each movable and configured to change according to a change in the angle of incidence θᵢ of the light beam 275, and for purposes of explanation, angle of incidence (θᵢ) is described below and illustrated in the following figure in more detail.

Again, electro-mechanical controls (not shown) can be provided in the optical assembly 240 for moving the optical input device 270 to substantially receive the reflected light beam 280. For example, by moving the optical input device 270 to another position 272, the optical input device 270 can detect the reflected light beam 280 as the angle of reflection θᵣ is changed due to a change in the angle of incidence θᵢ. The ability to adjust the relative positions of the optical input device 270 and/or optical output device 265 allows the detection of the reflected light beam 280 reflected off the optical reflective material 255. More specifically, adjusting the relative positions of the optical input device 270 and the optical output device 265 allows substantially all of the reflected light 280 to be detected, optimizing an absorbance measurement by at least the optical assembly 240 and input signal device 215. Detection of the intensity of the reflected light 280 can be used in generating an absorbance measurement, e.g., to determine the concentration of biological molecules in a sample.

In one aspect, the diameter of emitted light beam 265 from the optical assembly 240 and the dimension of the sample vessel are sized proportionally. That is, that substantially all of the emitted light 275 and reflected light 280 traveling between the optical output device 265 and the optical input device 270 of the optical assembly 240 travels through the sample vessel 245 and through the sample 150 contained in the sample vessel 245.

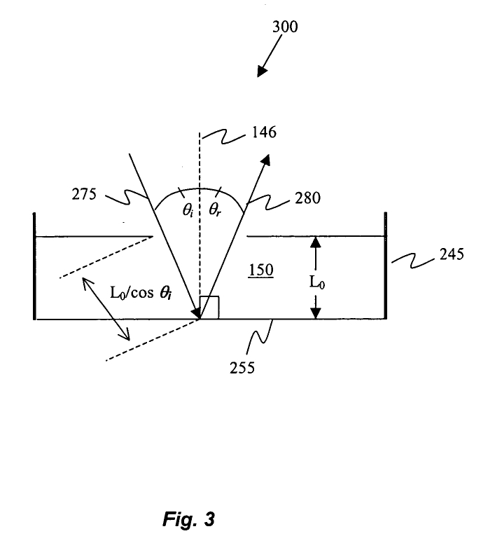

FIG. 3 illustrates a system for providing controllable pathlength through a sample, generally shown as 300. In the exemplary embodiment, a pathlength can be adjusted during a measurement of a sample 150 by varying the angles of incidences θᵢ of an emitted light 275 within a desired range. In one embodiment, the desired range of the angle of incidence θᵢ and the normal 246 is 5-65 degrees. However, any suitable angle of incidence can be used.

The sample vessel 245 can have one optical reflective surface 255, i.e., the light beam 275 will be reflected off a surface of sample vessel 245. However, the embodiment is not limited to a sample vessel 245 having an optical reflective surface 255, and the sample vessel 245 can have non-reflective surfaces or the like, and an alternate optical reflective surface which is not a part of the sample vessel can be disposed a distance away from the sample vessel 245 as illustrated in subsequent figures.

The sample 150 contained in sample vessel 245 occupies a space having a depth of L₀. In one aspect, the angle (i.e., angle of incidence θᵢ) created between the emitted light 275 and the normal 146 can be varied to provide a desired pathlength, where
Pathlength=2 L₀/(n*cos θᵢ) (2)
where L₀ is the depth or height the sample, θᵢ is the angle between the normal 146 and the emitted light 275, n is the refraction index. For most liquids, 1<n<2, and 2 L₀/(n* cos θᵢ) is greater than 2 L₀ when θᵢ is greater than zero (for simplicity, the angle of refraction is not shown in the figure). Similarly, according to the laws of reflection, the reflected light beam 280 makes a substantially similar angle (θᵣ) with the normal 146.

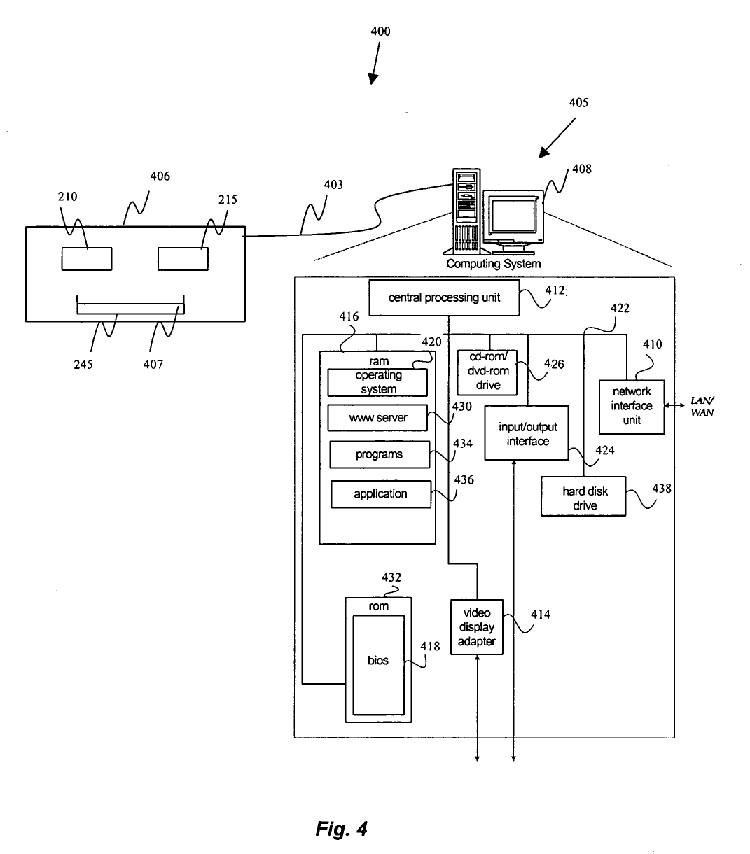

FIG. 4 illustrates a spectrophotometer system according to one embodiment of the invention, generally shown as 400. In the embodiment shown in the Figure, a computing system 405 is operatively coupled to a spectrophotometer 406 to provide a programmable processing system for the spectrophotometer 406. The computer system can be, but is not limited to, an embedded microprocessor and display, conventional PC, or handhold controller with human/machine interface. In certain aspects, the computer system is embodied in or accessed via a wireless device.

In one aspect, the spectrophotometer 406 includes a light source 210, a sample vessel 245, and a signal receiver device 215 as illustrated in FIG. 2. Communication between spectrophotometer 406 and the computer system 405 is provided by connection 403. The connection 403 can be any suitable communication link, such as hard-wire, RF or the like.

Referring to FIGS. 1 through 3, one will appreciate that the spectrophotometer 406 can include internal components (not shown) for processing the light traveling between the light source 210 and signal receiver device 215. Examples of such internal components include, but are not limited to, diffraction gratings, collimating mirrors or lenses, other mirrors or lenses, prisms, and the like. As with conventional spectrophotometers, the internal components measure light absorption, but can be designed to measure diffused or specular reflectance and process the light traveling between the optical output device 265 and optical input device 270 as shown in FIG. 2. In one embodiment, the spectrophotometer 406 is a photometer (a device for measuring light intensity) that can measure intensity as a function of the color, or more specifically, the wavelength of light.

In another embodiment, the spectrophotometer 406 can be a single beam or double beam spectrophotometer. A double beam spectrophotometer measures the ratio of the light intensity on two different light paths, and a single beam spectrophotometer measures the absolute light intensity. Although ratio measurements are easier, and generally have greater stability, single beam instruments have advantages, for instance they can have a larger dynamic range. In yet another embodiment, the spectrophotometer 406 is used in the UV and visible regions of the spectrum, or near-infrared regions.

The spectrophotometer 406 can use a monochromator to analyze a spectrum, an array of photo sensors, especially in the IR, or a Fourier transform technique, to acquire the spectral information called FTIR. The monochromator selects light from a narrow band of wavelengths using either a prism or a diffraction grating.

In one embodiment, in operation, the spectrophotometer 406 measures quantitatively the fraction of light that passes through a given solution 407. Initially, a blanking procedure is performed in which a wavelength light from the light source 210, typically from a deuterium gas discharge lamp, is guided through a monochromator, which picks light of one particular wavelength out of the continuous spectrum. This light passes through the sample vessel 245 to acquire an absorbance measurement when the sample 407 is not present. The blanking procedure is performed using the same angle(s) that will be used when making the measurement when the sample 407 is present. The resulting blanking light signal(s), which are a function of the incident angle, is stored in memory and used for data analysis, i.e., to compare the blanking measurement with the absorbance measurement when the sample 407 is present.

Then, the same particular wavelength light from a light source 210, at the same angle used in the blanking procedure, is passed through the sample 407 that is being measured. After passing through the sample 407, the intensity of the remaining light is detected by an optical input device 270 (such as shown in FIG. 2), such as a photodiode or other light sensor, and a signal representing at least the intensity of the remaining light for this wavelength is then sent to the signal receiver device 215 for processing. Further processing can be accomplished by the computer system 405. However, the invention is not limited to calculations and processing performed on the computer system 405 or signal receiver device 215; any suitable device can be used. Information processed by the computer system 405 can then be displayed on a monitor 408.

In one embodiment, the optical input device 270, or detector, lies on and is coplanar with the optical output device 265 of the spectrophotometer 406. However, other structures that are not coplanar can be used. The optical input device 270 can be, but is not limited to, a one-dimensional (1D-PDA) or two-dimensional (2D-PDA) photo-detector array that having rows of light sensitive photo-detectors that are sensitive to that part of the spectrum (i.e., light wavelengths) used to analyze various samples of interest. An example of an optical input device 270 includes a charge-coupled device (CCD) having rows of photodiodes formed in a semiconductor material such as a complimentary metal-oxide semiconductor (CMOS).

In one embodiment, the optical input device 270 outputs image data representative of the light intensity as a function of wavelength for the light signal output from the output optical fiber 220 via the optical output device 265. A signal receiver device 215 processes the output data or data acquisition device, which is a device that gathers, displays, and records the image data.

In another embodiment, the computing system 405 can process data received from the signal receiver device 215 and store the data in a memory, such as a random access memory 416. In some applications, the computing system 405 acts as a World Wide Web (web) server to transmit web pages to a web browser application program executing on requesting devices, to carry out this process. For example, a web server 430 may transmit pages and/or forms containing signal data from the signal receiver device 215. Moreover, the web server 430 can transmit web pages to a requesting device and allow a user to interact with web pages. The interaction can take place over the Internet, WAN/LAN, or any other suitable communications network.

The computing system 405 is not limited to the above-mentioned components and can include many more components than those shown in FIG. 4. However, the components shown are sufficient to disclose an illustrative embodiment for practicing one possible embodiment. For example, in one aspect, the computing system 405 is connected to a WAN/LAN, or other communications network, via network interface unit 410. Hence, it will be appreciated that the network interface unit 410 includes the necessary circuitry for connecting computing system 405 to WAN/LAN, and is constructed for use with various communication protocols including the TCP/IP protocol. Typically, the network interface unit 410 is a card contained within the computing system 405.

The computing system 405 also includes processing unit 412, video display adapter 414, and a memory, all connected via bus 422. The memory can include RAM 416, ROM 432, and one or more permanent storage devices, such as hard disk drive 438, a tape drive, CD-ROM/DVD-ROM drive 426, and/or a floppy disk drive. The memory stores operating system 420 for controlling the operation of the programmable computing system 405. It will be appreciated that this component may comprise a general-purpose server operating system such as UNIX, LINUX™, or Microsoft WINDOWS NT®. Basic input/output system (“BIOS”) 418 is also provided for controlling the low-level operation of computing system 405.

The memory as described above illustrates another type of computer-readable media, namely computer storage media, encompassed within the scope of the invention. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

In one embodiment, the memory also stores program code and data for providing a website. More specifically, the memory stores applications including a web server application program 430, support programs 434, and a processing application 436 to process output from the signal receiver device 215. Web server application program 430 includes computer executable instructions which, when executed by the system computer 405, generate web browser displays, including performing the logic described above. The computing system 405 may include a JAVA virtual machine, an SMTP handler application for transmitting and receiving email, an HTTP handler application for receiving and handing HTTP requests, JAVA applets for transmission to a web browser executing on a client computer, and an HTTPS handler application for handling secure connections. The HTTPS handler application may be used for communication with external security applications (not shown), to send and receive private information in a secure manner.

The computing system 405 also comprises input/output interface 424 for communicating with external devices, such as a mouse, keyboard, scanner, or other input devices not shown in FIG. 4. Likewise, computing system 405 may further comprise additional mass storage facilities such as CD-ROM/DVD-ROM drive 426 and hard disk drive 438. Hard disk drive 438 is utilized by computing system 405 to store, among other things, application programs, databases, and program data used by web server application program 430. For example, customer databases, product databases, image databases, and relational databases may be stored. The operation and implementation of these databases is well known to those skilled in the art.

In the generation of the web pages and related view display data, the data may be formatted into any number of data formats without deviating from the spirit and scope of the embodiment. For many web pages, the use of HTML may be adequate; however, the multimedia data may be provided in any number of data formats including flash data in the format created and supported by Macromedia Corporation, QuickTime data in the format created and supported by Apple Computer, and Real Audio data in the format created and supported by Real Inc. The embodiment is not limited the above-mentioned data formats and the choice of the multimedia data format, and its supporting server and client programs, is one of any suitable design choice with an alternate choices also falling within the spirit and scope of the embodiment.

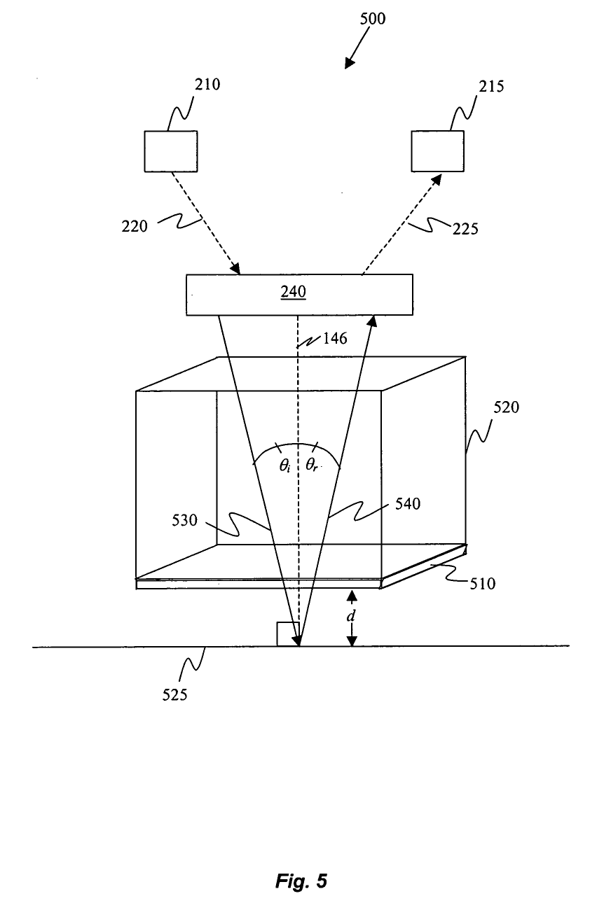

FIG. 5 is an alternate embodiment of a system for increasing pathlength by light reflection, generally shown as 500. In FIG. 5, a sample 510 is contained in a sample vessel 520. The sample vessel 520 can be any made of any optical or non-optical material, such as quartz, silica, glass, polystyrene, methacrylate, UV-transparent plastic or the like. The optical assembly 240 determines the angle of incidence θᵢ of the emitted light 530 from the light source 210 (for simplicity, the angle of refraction is not shown in the figure). The emitted light 530 then passes completely through a sample 510 and the sample vessel 520 at a predetermined angle θ (e.g., angle of incidence θᵢ). The emitted light 530 is reflected off an optical reflective material 525 disposed at a distance d from the sample vessel 520. The reflected light beam 540 is detected by the optical assembly 240 and processed according to equation 2 above.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of spectrophotometric measurement of a sample, the method comprising:
transmitting a light through a sample;
adjusting an angle of incidence of the light to vary a pathlength of the light transmitted through the sample; and
measuring the intensity of the light that passed through the sample.

2. The method of claim 1, wherein transmitting the light through a sample further comprises:
transmitting a light through the sample a first time;
reflecting the light off a surface normal to the sample as to transmit the light through the sample a second time; and
determining the absorbance of the light emitted from the sample the second time by measuring the intensity of the emitted light.

3. The method of claim 2, wherein reflecting the light off the surface further comprised reflecting the light off an optical reflective material.

4. The method of claim 1, wherein adjusting the angle of incidence further comprises increasing the pathlength by increasing an angle of incidence of the light through the sample.

5. The method of claim 1, wherein adjusting the angle of incidence further comprises decreasing the pathlength by decreasing the angle of incidence of the light through the sample.

6. The method of claim 2, wherein determining the absorbance further comprises performing blanking by measuring an absorbance level when the sample is a blanking sample.

7. The method of claim 1, wherein conducting a light through a sample further comprises providing at least one optical fiber providing a first light path from a light source to the sample and at least one optical fiber providing a second light path from the sample to a detector, and the act of passing the light between the first and second light paths through the sample includes adjusting the positions of the first and/or second light paths to optimize the intensity measurement.

8. The method of claim 7, wherein providing at least one optical fiber forming the first and second light paths further comprises conducting light from the sample to the detector, and the act of conducting light from the sample to the detector includes conducting light along at least one optical fiber coupled to the detector.

9. The method of claim 8, wherein transmitting light from the sample to the detector further comprises projecting the light onto a charge-coupled device.

10. The method of claim 8, wherein transmitting light from the samples to the detector further comprises projecting the light onto a photoelectric sensor.

11. The method of claim 1, wherein transmitting the light through a sample further comprises transmitting the light through a sample vessel having a sample depth of about 0.1 to 5 mm.

12. The method of claim 2, wherein determining the absorbance further comprises processing an absorbance measurement signal generated by the detector.

13. A spectrophotometer for analyzing a sample, comprising:
a light source;
an optical assembly arranged to receive light from the light source and to project the light through a sample, the optical assembly configured to vary an angle of incidence of the light projected through the sample.

14. The spectrophotometer of claim 13, further comprising
a reflective surface to reflect the light through the sample; and
a detector arranged to detect the reflected light.

15. The spectrophotometer of claim 14, wherein the detector comprises a charge-coupled device.

16. The spectrophotometer of claim 13, wherein the optical assembly is coupled to at least one optical fiber arranged between the light source and the sample.

17. The spectrophotometer of claim 16, wherein the optical assembly includes at least one lens positioned between the optical fiber and the sample, the at least one lens configured to vary a pathlength of the light through the sample by adjusting an angle of incidence of the light radiated from the optical fiber with the reflective surface.

18. The spectrophotometer of claim 13, wherein the optical assembly is coupled to at least one optical fiber arranged between the sample and the detector.

19. The spectrophotometer of claim 18 wherein the optical fiber arranged between the sample and the detector has a first end positioned to receive light from the sample and a second end positioned to direct light onto the detector.

20. The spectrophotometer of claim 13, wherein the optical assembly further comprises at least a first lens positioned between an optical fiber and the sample for varying a pathlength of the light through the sample; and
at least a second lens positioned between the sample and the detector to receive light from the sample;
wherein at least first and second lenses are adjusted to optimize an intensity measurement of the light projected through the sample.

21. The spectrophotometer of claim 13, wherein the sample vessel includes the optically reflective surface and light transmittable surface having an open surface to the sample.

22. The spectrophotometer of claim 13, wherein an optically reflective surface is positioned at a predetermined distance from the sample vessel.

23. The spectrophotometer of claim 13 further comprising a processor for determining the absorbance of reflected light by processing a signal representing the intensity of the reflected light emitted from sample.
